(19) United States
(12) Patent Application Publication
(10) Pub. No.: US 2021/0315059 A1
(43) Pub. Date: Oct. 7, 2021

(54) HEATING CORE ASSEMBLY OF ATOMIZER AND ELECTRONIC CIGARETTE COMPRISING SAME

(71) Applicant: Yang Liu, Mudanjiang (CN)

(72) Inventor: Yang Liu, Mudanjiang (CN)

(21) Appl. No.: 17/353,796

(22) Filed: Jun. 21, 2021

Related U.S. Application Data
(63) Continuation of application No. PCT/CN2019/086938, filed on May 15, 2019.

(30) Foreign Application Priority Data
Dec. 24, 2018 (CN) 201811581660.8

(51) Int. Cl. H05B 1/02; A24F 40/46; A24F 40/10; A24F 40/44; A24F 40/485; H05B 3/03; H05B 3/42

(52) U.S. Cl. CPC H05B 1/0297; A24F 40/46; A24F 40/10; H05B 2203/021; A24F 40/485; H05B 3/03; H05B 3/42; A24F 40/44

(57) ABSTRACT

A heating core assembly (10) of an atomizer and an electronic cigarette comprising the same. The heating core assembly (10) of an atomizer comprises a heating tube (11) and a liquid guiding member (12) sleeved around an outer circumference of the heating tube (11). The outer circumference of the heating tube (11) is closely engaged with the liquid guiding member (12). The heating tube (11) is a conductive metal, and two ends of the heating tube (11) are both electrically conductive. Two ends of the heating core assembly (10) are respectively connected to positive and negative electrodes of a power supply by means of a pin (231) and a connecting rod (26). The pin (231) and the connecting rod (26) extend to an inner side of the heating tube (11) so as to supply electricity to the heating tube (11).

### CROSS REFERENCE TO RELATED APPLICATIONS

The present application is a Continuation Application of PCT Application No. PCT/CN2019/086938 filed on May 15, 2019, which is based on a Chinese patent application No. 201811581660.8 filed on Dec. 24, 2018, and claims its priority. The entire disclosure of the application is incorporated herein by reference in its entirety.

### FIELD OF TECHNOLOGY

The present application relates to an electronic cigarette, and particularly to a heating core assembly of an atomizer and an electronic cigarette comprising same.

### BACKGROUND TECHNOLOGY

Existing electronic cigarette has two leads at both ends connected with positive and negative electrodes of a power supply in order to connect the heating tube to the power. This results in complicated structure, and the positive and negative electrodes need to be distinguished, which affects the production efficiency. In addition, the liquid guiding member and the heating tube are manually wound up, which easily causes pollution during the production process.

### SUMMARY

The objective of the present application is to provide a heating core assembly of an atomizer and an electronic cigarette comprising same, in order to overcome the above defects of the prior art.

In order to achieve the above objectives, the following technical proposals are provided by the present application:

a heating core assembly of an atomizer, which includes a heating tube and a liquid guiding member sleeved on an outer circumference of the heating tube, the outer circumference of the heating tube is closely fitted to the liquid guiding member, the heating tube is made of conductive metal, and two ends thereof are both electrically conductive.

Further, the outer circumference of the heating tube is provided with liquid passing holes that are aligned in a jagged manner.

Further, the liquid guiding member is liquid guiding cotton.

An electronic cigarette that is easy to assemble includes a casing, a first end cover mounted at one end of the casing, and a second end cover mounted at the other end of the casing. A fixing base for installing the above-mentioned heating core assembly is provided between the first end cover and the second end cover. An oil storage cavity is formed between the casing, the first end cover, the second end cover, and the fixing base.

Further, two ends of the fixing base are detachably connected with the first end cover and the second end cover, and liquid communicating holes are open on an outer periphery of the fixing base.

Further, the first end cover is provided with a connecting rod which is extended to an inside of the heating tube. The connecting rod is in electrical connection with the heating tube and is connected to a negative electrode of a power supply.

Further, the first end cover includes an inner fixing cover fixedly connected to the casing, and an outer fixing cover connected with the inner fixing cover. The connecting rod is arranged on and integrally formed with the inner fixing cover. The connecting rod is provided with a tapered portion, and the tapered portion is inserted into the inside of the heating tube to establish an electrical connection. The connecting rod has a hollow structure and is in communication with a suction nozzle on the first end cover. A gasket is arranged between the inner fixing cover and the outer fixing cover. An end surface of the inner fixing cover is provided with a silicone ring, so that the inner fixing cover and the casing are connected in a sealed manner, thereby preventing the oil storage cavity from leakage.

Further, a pin is provided on the second end cover. The pin is extended to the inside of the heating tube and electrically connected to the heating tube, and the pin is connected to a positive electrode of the power supply.

Further, the pin is provided with an inclined surface, and the inclined surface is extended to the inside of the heating tube and is in electrical contact with the heating tube. An insulating sleeve is disposed between the pin and the second end cover.

Further, the second end cover also includes a first cover body detachably connected to the fixing base and a second cover body fixedly connected to the first cover body, and the pin is fixedly connected to the second cover body through the insulating sleeve. An end surface of the second cover body is provided with a silicone sleeve, so that the second cover body and the casing are connected in a sealed manner.

Further, a rotating sleeve is arranged on an outside of the second cover body, and the rotating sleeve is rotatable with respect to the second cover body. The rotating sleeve and the second cover body are both provided with air inlets, and size of the air inlets may be adjusted by rotating the rotating sleeve.

The advantageous effects of the present application compared with the prior art is that two ends of the heating core assembly of the present application are connected to the positive and negative electrodes of the power supply through the pin and the connecting rod, and the pin and the connecting rod are extended to the inside of the heating tube to supply power to the heating tube. The two ends of the heating tube are electrically connected with the pin and the connecting rod, thus no leads are required for the heating tube, and each end of the heating tube may be connected to either a positive and negative electrode, which improves production efficiency and facilitates assembly.

The application will be further described below with reference to the accompanying drawings and specific embodiments.

### BRIEF DESCRIPTION OF THE DRAWINGS

FIG. 1 is a perspective structural view of the heating core assembly of the atomizer of the present application;

FIG. 2 is a cross-sectional view of the heating core assembly of the atomizer of the present application;

FIG. 3 is a perspective structural view of the electronic cigarette that is easy to assemble of the present application;

FIG. 4 is an exploded view of the electronic cigarette that is easy to assemble of the present application;

FIG. 5 is a cross-sectional view of the electronic cigarette that is easy to assemble of the present application;

FIG. 6 is a structural view of the integrally formed connecting rod and inner fixing cover of the electronic cigarette that is easy to assemble of the present application; and

FIG. 7 is a perspective structural view of the pin of the electronic cigarette that is easy to assemble of the present application.

### DETAILED DESCRIPTION OF THE EMBODIMENTS

In order to more fully understand the technical content of the present application, the technical proposal of the present application is further described and explained in conjunction with detailed embodiments below, but is not limited thereto.

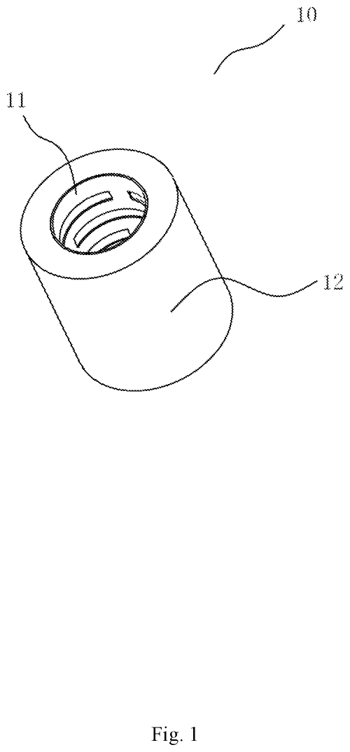

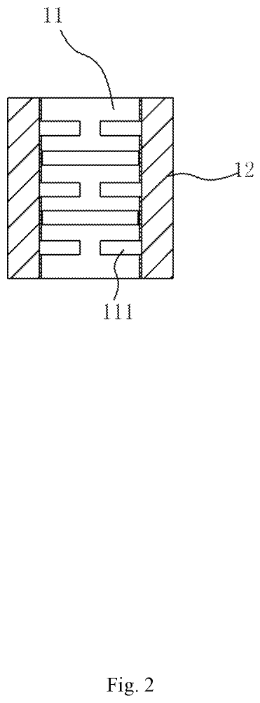

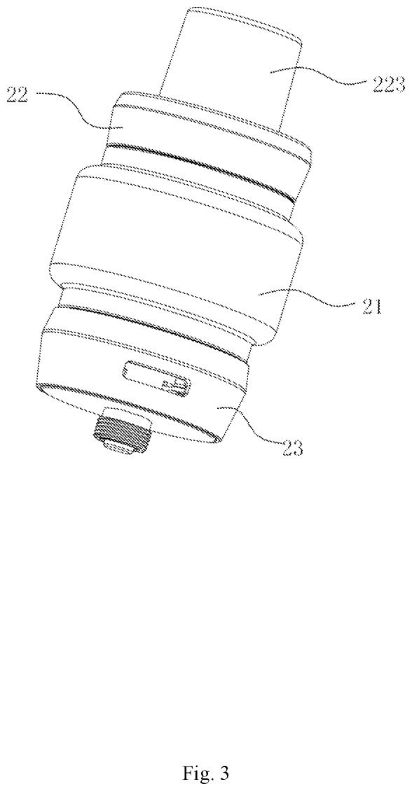

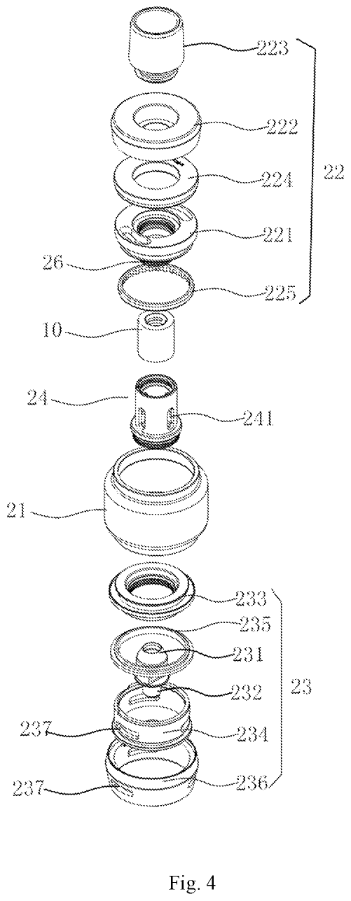

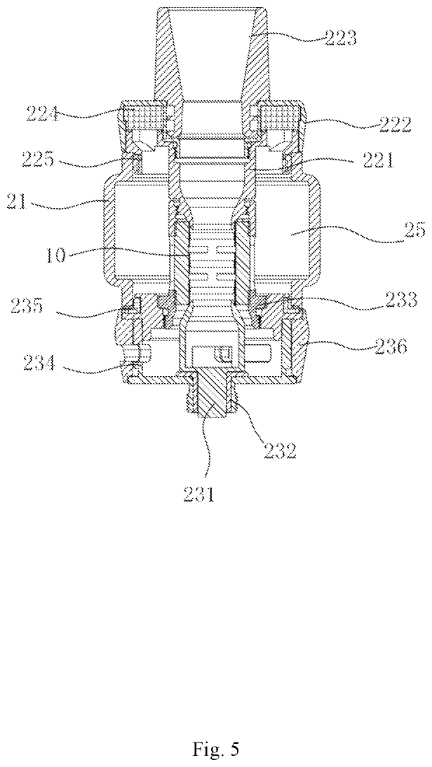

FIGS. 1-7 show the drawings of the present application.

A heating core assembly 10 of an atomizer, which includes a heating tube 11 and a liquid guiding member 12 sleeved on an outer circumference of the heating tube 11, the outer circumference of the heating tube 11 is closely fitted to the liquid guiding member 12, the heating tube 11 is made of conductive metal, and two ends thereof are both electrically conductive.

The outer circumference of the heating tube 11 is provided with liquid passing holes 111 that are aligned in a jagged manner, so that e-liquid can effectively enter into an inner cavity of the heating tube 11 from the liquid guiding member 12 and be fully atomized.

The liquid guiding member 12 is liquid guiding cotton, a liquid guiding cloth, a liquid guiding foam, and the like.

The heating core assembly 10 is integrally formed. During the production process, the liquid guiding member 12 is installed on an outer side of the heating tube 11 by automatic equipment to form an integrated structure, which is facilitates later installation.

An electronic cigarette that is easy to assemble includes a casing 21, a first end cover 22 mounted at one end of the casing 21, and a second end cover 23 mounted at the other end of the casing 21. A fixing base 24 for installing the above-mentioned heating core assembly 10 is provided between the first end cover 22 and the second end cover 23. An oil storage cavity 25 is formed between the casing 21, the first end cover 22, the second end cover 23, and the fixing base 24. E-liquid in the oil storage cavity 25 permeates to the surrounding of the heating tube 11 through the liquid guiding member 12. The heating tube 11 is connected to power to generate heat, and the e-liquid is heated and atomized.

The fixing base 24 is connected with the first end cover 22 and the second end cover 23 through threads to seal the oil storage cavity 25 and prevent leakage of the oil storage cavity 25 into the heating tube. Liquid communicating holes 241 are open on an outer periphery of the fixing base 24.

The first end cover 22 is provided with a connecting rod 26 which is extended to an inside of the heating tube 11. The connecting rod 26 is in electrical connection with the heating tube 11 and is connected to the negative electrode of a power supply. The connecting rod 26 is provided with external threads that cooperate with internal threads provided on an end portion of the fixing base 24, and the connecting rod 26 is in contact with an inner wall of the heating tube 11 to conduct electricity. The connecting rod 26 is connected to the negative electrode of the power supply through the first end cover 22.

The first end cover 22 includes an inner fixing cover 221 fixedly connected to the casing 21, and an outer fixing cover 222 connected with the inner fixing cover 221. The connecting rod 26 is disposed on a side of the inner fixing cover 221 facing the fixing base 24.

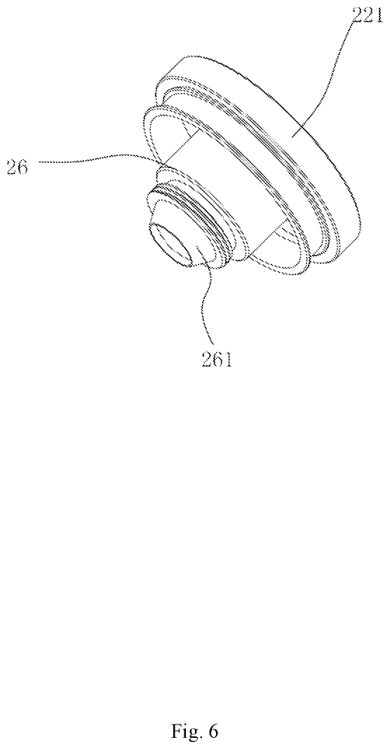

Preferably, as shown in FIG. 6, the connecting rod 26 is integrally formed with the inner fixing cover 221.

The connecting rod 26 is provided with a tapered portion 261, and the tapered portion 261 is inserted into the inside of the heating tube 11 to establish an electrical connection. The connecting rod 26 has a hollow structure and is in communication with a suction nozzle 223 on the first end cover 22. A gasket 224 is arranged between the inner fixing cover 221 and the outer fixing cover 222. An end surface of the inner fixing cover 221 is provided with a silicone ring 225, so that the inner fixing cover and the casing 21 are connected in a sealed manner, thereby preventing the oil storage cavity 25 from leakage.

The hollow structure of the inner fixing cover 221 is provided with internal threads, and the outer fixing cover 222 is provided with external threads, and the internal threads and the external threads cooperate with each other. The gasket 224 is located and pressed between the inner fixing cover 221 and the outer fixing cover 222.

A pin 231 is provided on the second end cover 23. The pin 231 is extended to the inside of the heating tube 11 and electrically connected to the heating tube 11, and the pin 231 is connected to a positive electrode of the power supply.

The pin 231 is provided with an inclined surface 2311, and the inclined surface 2311 is extended to the inside of the heating tube 11 and is in electrical contact with the heating tube 11. An insulating sleeve 232 is disposed between the pin 231 and the second end cover 23.

The second end cover 23 also includes a first cover body 233 connected to the fixing base 24 through threaded connection and a second cover body 234 fixedly connected to the first cover body 233, and the pin 231 is fixedly connected to the second cover body 234 through the insulating sleeve 232. An end surface of the second cover body 234 is provided with a silicone sleeve 235, so that the second cover body 234 and the casing 21 are connected in a sealed manner.

A rotating sleeve 236 is arranged on an outside of the second cover body 234, and the rotating sleeve 236 is rotatable with respect to the second cover body 234. The rotating sleeve 236 and the second cover body 234 are both provided with air inlets 237, and size of the air inlets 237 may be adjusted by rotating the rotating sleeve 236.

The second cover body 234 has an inner cavity, with the pin 231 positioned therein. The air inlets 237 is in communication with the inner cavity of the heating tube 11, so that air enters from the air inlets 237 when inhaling, and the e-liquid atomized by the heating tube 11 is discharged from the suction nozzle.

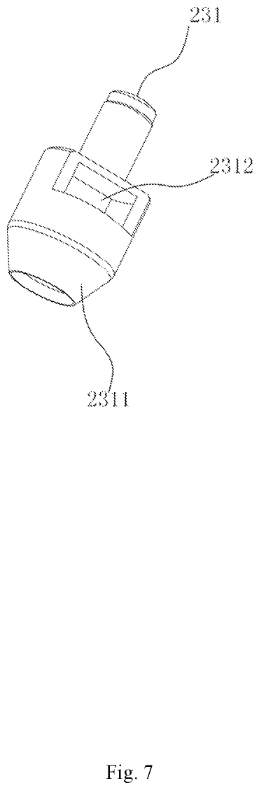

Preferably, as shown in FIG. 7, the pin 231 has a hollow structure with a through-hole 2312 open on the outer side of the pin 231, and the hollow structure of the pin 231 is in communication with the inner cavity of the heating tube 11, so that incoming air from the air inlets 237 enters the internal cavity of the heating tube 11 through the through-hole 2312 of the pin 231.

The second end cover 23 is detachably connected with the power supply provided.

In summary, two ends of the heating core assembly of the present application are connected to the positive and negative electrodes of the power supply through the pin and the connecting rod, and the pin and the connecting rod are extended to the inside of the heating tube to supply power to the heating tube. The two ends of the heating tube are electrically connected with the pin and the connecting rod, thus no leads are required for the heating tube, and each end of the heating tube may be connected to either a positive and negative electrode, which improves production efficiency and facilitates assembly.

The above are merely examples to further illustrate the technical content of this application for easier understanding of readers, but are not intended to limit the implementation of this application. Any technical extension or re-creation made according to this application falls within the scope of protection of this application. The scope of protection of this application is subject to the claims.

1. A heating core assembly of an atomizer, comprising
a heating tube; and
a liquid guiding member sleeved on an outer circumference of the heating tube, the outer circumference of the heating tube being closely fitted to the liquid guiding member,
wherein the heating tube is made of conductive metal, and two ends thereof are both electrically conductive.

2. The heating core assembly of an atomizer according to claim 1, wherein the outer circumference of the heating tube is provided with liquid passing holes that are aligned in a jagged manner.

3. The heating core assembly of an atomizer according to claim 1, wherein the liquid guiding member is liquid guiding cotton.

4. An electronic cigarette that is easy to assemble, comprising
a casing;
a first end cover mounted at one end of the casing; and
a second end cover mounted at the other end of the casing,
wherein a fixing base for installing the heating core assembly according to claim 1 is provided between the first end cover and the second end cover, and
wherein an oil storage cavity is formed between the casing, the first end cover, the second end cover, and the fixing base.

5. The electronic cigarette that is easy to assemble according to claim 4, wherein two ends of the fixing base are detachably connected with the first end cover and the second end cover, and liquid communicating holes are open on an outer periphery of the fixing base.

6. The electronic cigarette that is easy to assemble according to claim 4, wherein the first end cover is provided with a connecting rod, which is extended to an inside of the heating tube, the connecting rod is in electrical connection with the heating tube and is connected to a negative electrode of a power supply.

7. The electronic cigarette that is easy to assemble according to claim 6, wherein the first end cover comprises an inner fixing cover fixedly connected to the casing, and an outer fixing cover connected with the inner fixing cover, the connecting rod is arranged on the inner fixing cover, and the connecting rod is provided with a tapered portion inserted into the inside of the heating tube to establish an electrical connection.

8. The electronic cigarette that is easy to assemble according to claim 4, wherein a pin is provided on the second end cover, the pin is extended to the inside of the heating tube and is electrically connected to the heating tube, and the pin is connected to a positive electrode of the power supply.

9. The electronic cigarette that is easy to assemble according to claim 8, wherein the pin is provided with an inclined surface that is extended to the inside of the heating tube and is in electrical contact with the heating tube, and an insulating sleeve is disposed between the pin and the second end cover.

10. The electronic cigarette that is easy to assemble according to claim 9, wherein the second end cover further comprises a first cover body detachably connected to the fixing base and a second cover body fixedly connected to the first cover body, and the pin is fixedly connected to the second cover body through the insulating sleeve, an end surface of the second cover body is provided with a silicone sleeve, so that the second cover body and the casing are connected in a sealed manner.
